(19) United States
(12) Patent Application Publication
(10) Pub. No.: US 2010/0084851 A1
(43) Pub. Date: Apr. 8, 2010

(54) SECURITY ELEMENT

(75) Inventor: Andreas Schilling, Hagendorn (CH)

Correspondence Address: HOFFMANN & BARON, LLP, 6900 JERICHO TURNPIKE, SYOSSET, NY, 11791, US

(73) Assignee: Leonhard Kurz Stiftung & Co KG, Furth (DE)

(21) Appl. No.: 12/449,420

(22) PCT Filed: Feb. 7, 2008
(86) PCT No.: PCT/EP2008/000941

§ 371 Date: Oct. 20, 2009

(30) Foreign Application Priority Data
Feb. 7, 2007 (DE) 102007005884.7
Nov. 28, 2007 (DE) 102007057658.9

(51) Int. Cl. B42D 15/00; D21H 21/44; B42D 15/10

(52) U.S. Cl. 283/91; 283/85

(57) ABSTRACT

The invention relates to a security document (3) in the form of a multilayer film body for viewing in incident light and in transmitted light. The security (3) element has a carrier film (31) and a partial metallic reflective layer (34) in a first region (40) that is transparent or semi-transparent when viewed by a human in transmitted light. In the first region (40), first zones (41) which are provided with the metallic reflective layer, and second zones (42) which are not provided with the metallic reflective layer, are alternately arranged, the centers of gravity of consecutive first zones (41) being interspaced at less than 300 μm. The first region (40) has at least one patterned region with dimensions >300 μm and at least one background region, adjoining the patterned region and at least partially enclosing the background region, the distances of consecutive second regions (42) in the patterned region differing by 5 to 30% in relation to the distances of consecutive second regions (42) in the background region, thereby making an information that is defined by the form of the patterned region visible in transmitted light when viewed by a human.

The invention concerns a security element in the form of a multi-layer film body for viewing in the incident light mode and in the transillumination mode, wherein the security element has a region which is transparent or semi-transparent for the human viewer in the transillumination mode.

It is necessary for security documents to be provided with security features which make it difficult to forge those documents and to prevent forgery as much as possible. In that respect it is already known for security documents to be provided with transmissive security features which can be checked when viewed in a transillumination mode and which afford a particularly high level of security against imitation by means of a colour copier. Thus for example DE-A-433-4847 describes a security document in which openings in window form are produced by means of a stamping or cutting operation in the carrier of the security document. Those openings are then closed by means of an at least region-wise transparent cover film which projects beyond the openings on all sides and which is fixed on the surface of the carrier over the full surface area. That cover film provides inter alia a security element which is generated by a diffractive structure which is arranged within the transparent window and which is backed by a metallic reflection layer. That provides a security feature within the transparent window, the security feature being visible in the incident light mode.

Now the object of the invention is to provide a security element for viewing in the incident light and transillumination mode, with a high level of security against forgery.

That object is attained by a security element in the form of a multi-layer film body for viewing in the incident light mode and in the transillumination mode, wherein the security element, in a first region which is transparent or semi-transparent for the human viewer in the transillumination mode, has a carrier film and a partial metallic reflection layer, wherein in the first region first zones in which the metallic reflection layer is provided and second zones in which the metallic reflection layer is not provided are arranged alternately with a spacing of the centroids of successive first zones of less than 300 μm, the first region has at least one pattern region with dimensions >300 μm and at least one background region adjoining the pattern region and at least partially surrounding the pattern region, wherein the spacing of successive second zones in the pattern region differs by 5 to 30% with respect to the spacing of successive second zones in the background region, whereby an item of information determined by the shaping of the pattern region becomes visible to the human viewer in the transillumination mode.

It was surprisingly found that when observing the above-described dimensional rules, the first information is not visible to the human viewer in the incident light mode but suddenly appears in the transillumination mode. The first region thus has a different optical appearance for the human viewer in the incident light mode and in the transillumination mode, whereby a clearly recognisable and easily remembered security element is afforded by the invention. That security element also cannot be imitated by means of a colour copier or other technical measures so that the security element has a high level of safeguard against imitation and forgery. Moreover the security element according to the invention can be produced in few production steps and does not require the use of expensive materials, and it is therefore also particularly inexpensive to produce.

Advantageous developments of the invention are set forth in the appendant claims.

In accordance with a preferred embodiment of the invention the first zones are of a line-shaped or strip-shaped configuration. In that case preferably the width of the first zones is less than 200 μm and the length of the first zones is considerably greater than the width and is preferably >1000 μm. In a further preferred feature the width of the first zones is between 10 μm and 100 μm, further preferably between 10 μm and 40 μm. By observing those dimensions it is possible to attain and achieve a high difference in contrast, so that diffraction phenomena which interfere with the optical impression and random interplays of colour are substantially avoided.

It has further proven to be advantageous if in the first region the total surface area of the first zones occupies an area proportion of less than 50% of the total area of the first and second zones, preferably less than 10% of the total area of the first and second zones. In addition the ratio of the first and second regions to each other is preferably selected to be between 70% and 95%. By observing those conditions, that provides a particularly marked distinction between the optical impression of the first region in the incident light mode and in the transillumination mode.

In accordance with a preferred embodiment of the invention the first zones are arranged substantially parallel to each other, wherein the longitudinal axes of the first zones are oriented in the direction of a first co-ordinate axis of a co-ordinate system defined by the first co-ordinate axis and a second co-ordinate axis different therefrom in the first region. The co-ordinate system can involve a co-ordinate system defined by two straight lines disposed at a right angle to each other. It is however also possible for the co-ordinate system to involve a geometrically transformed co-ordinate system whose co-ordinate axes are for example in the form of serpentine lines or circles. Preferably, in the case of such a transformed co-ordinate system, the co-ordinate axes are also oriented at a right angle to each other.

Preferably first zones extend over the boundary between a pattern region and a background region. The respective first zone is provided both in the pattern region and also in the background region and is not interrupted at the boundary between the pattern region and the background region. That provides for avoiding diffraction phenomena which interfere with the optical impression and which otherwise under certain conditions allow the attentive viewer to guess at the first item of information in the incident light mode. Thus those measures further increase the contrast between the optical impression in the incident light mode and in the transillumination mode. Preferably in that respect the first zones extend over the entire surface extent of the first region in the direction of the first co-ordinate axis.

In a preferred embodiment of the invention the centroid lines of the first zones are substantially constantly spaced along the first co-ordinate axis in the direction of the second co-ordinate axis. That measure provides for a regular uniform background, against which the pattern region particularly clearly appears when viewing in the transillumination mode. It is however also possible that the centroid lines of the first zones are varied along the first co-ordinate axis in the direction of the second co-ordinate axis in accordance with a function which specifies a second item of information. That second item of information, insofar as it involves a periodicity, preferably has a period spacing of more than 300 μm. The second item of information can further also form a grey scale image which uniformly superposes the pattern region and the background region, for example a portrait, which appears both when viewed in the incident light and in the transillumination mode and which when viewed in the transillumination mode is further superposed by the first information generated by the difference in contrast between the background region and the pattern region.

It has further proven to be advantageous if the centroid lines of the first zones are spaced from each other at between 30 and 40 μm in the direction of the second co-ordinate axis. It has been found that in that way the differences in contrast between the optical appearance when viewing in the incident light and in the transillumination mode clearly appear and troublesome influences and colour shifts are substantially avoided.

In accordance with a preferred embodiment of the invention the width of the first zones in the pattern region and the width of the first zones in the background region differ by 10 to 30%, preferably between 15 and 25%. Investigations have shown that a particularly great difference in contrast between viewing in the incident light mode and the transillumination mode is also achieved in that way.

In accordance with a further embodiment of the invention one or more of the first zones is microstructured to provide a third item of information. It is thus possible for example to microstructure a first region which is in strip form from the base structure, in the form of numbers, letters or symbols, and they can be read out by means of a technical aid, for example a magnifying glass. In that respect microstructured means that in the region of those microscopic numbers, letters or symbols, the metallic reflection layer is also not provided.

In accordance with a preferred embodiment of the invention a surface structure is shaped into the surface of the replication layer, at least in a subregion of the first region in the first zones. That surface structure is preferably an isotropic or an anisotropic matt structure. It is however also possible for that surface structure to be another diffractive surface structure, for example a Kinegram® or a hologram. The optical effect generated by that surface structure appears when viewed in the incident light mode so that a particularly marked difference between the optical appearance in the incident light mode and in the transillumination mode is generated. In particular the use of matt structures which provide for scattered reflection of the incident light when viewed in the incident light mode and which by virtue of that effect additionally prevent recognisability of the first information when viewing in the incident light mode is desirable. That can be used to further increase the difference in contrast between the background region and the pattern region when viewed in the transillumination mode and thus to provide that the first information is particularly clearly apparent when viewing in the transillumination mode.

The surface structure can here be shaped in the first region in the first zones over the entire surface area or over part of the surface area. If the surface structure is shaped only in a subregion of the first region that subregion is preferably so selected that, entirely or for the major part, it covers the pattern region and a part of the background region adjoining the pattern region. Furthermore it is also possible to introduce a further fourth item of information into the first region by shaping of the surface structure, that fourth item of information being visible when viewed in the incident light and/or transillumination mode, as described hereinafter. That makes it possible by means of the invention to achieve further interesting optical effects.

The object of the invention is thus further attained by a security element in the form of a multi-layer film body for viewing in the incident light mode and in the transillumination mode, wherein the security element, in a first region which is transparent or semi-transparent for the human viewer in the transillumination mode, has a carrier film and a partial metallic reflection layer, in which first zones in which the metallic reflection layer is provided and second zones in which the metallic reflection layer is not provided are provided alternately in the first region, wherein each of the first and second zones within the first region is of a smallest dimension of less than 300 μm, and the first region has at least one pattern region of dimensions of greater than 300 μm and at least one background region adjoining the pattern region and at least partially enclosing the pattern region, wherein within the first region in at least a part of the surface, occupied by the first zones, of the background region and of the pattern region a respective first surface structure is shaped into the reflection layer, which deflects the incident light at least partially out of the mirror reflection of the plane defined by the film body and the surface area proportion of the first zones in relation to the total surface area of each pattern region differs from the surface area proportion of the first zones in relation to the total surface area of each background region by 5 to 30%, whereby a first item of information determined by the shaping of the pattern region becomes visible to the human viewer in the transillumination mode.

It was also surprisingly found, when those conditions were observed, that an item of information is not visible to the human viewer when viewed in the incident light mode, but suddenly appears in the transillumination mode. In accordance with this aspect of the invention, the conditions to be observed in regard to the structuring of the metallic reflection layer are admittedly less tight, but here there is additionally provided the first surface structure which acts as a ‘veiling structure’ and additionally provides that the items of information which are visible in the incident light mode and in the transillumination mode are markedly different. This aspect of the invention is thus based on the notion that perception of the human eye when viewing in the incident light mode and in the transillumination mode is different and suitable structuring of the pattern region and the background region can provide that information can be encoded in the first region, which information is not visible to the human viewer when viewed in the incident light mode, but appears when viewed in the transillumination mode. The security element according to the invention provides a clearly recognisable and easily remembered security feature which cannot be imitated by means of a colour copier or other technical measures so that the security element has a high level of safeguard against imitation and forgeries. Furthermore the security element according to the invention can be produced in a few production steps and does not require the use of expensive materials, and is thus also particularly inexpensive to manufacture.

Preferably the first and second zones are shaped in the first region as described hereinbefore and attention is thus directed to the foregoing description. Furthermore, when using the ‘veiling structure’ which is now also involved, it is possible to use further variants for shaping of the first and second zones in the first region in combination with the veiling structure and in that way also to achieve the above-described effects. In regard to the configuration of the first and second zones in the first region, in that respect in particular the following variants have proven to be advantageous:

In accordance with a preferred embodiment of the invention the centroids of successive first zones are spaced at less than 300 μm from each other at least in one direction. The width of the first zones is in this case also preferably selected to be between 10 μm and 150 μm, further Preferably between 10 μm and 100 μm. Observing those dimensions gives a high difference in contrast and provides that diffraction phenomena which interfere with the optical impression, and random colour interplays, are substantially avoided.

In addition it is possible for the centroids of successive first zones to be spaced from each other at less than 300 μm both in the direction of a first co-ordinate axis and in the direction of a second co-ordinate axis differing therefrom of a co-ordinate system defined in the first region by said co-ordinate axes. In this case the co-ordinate system can also be a geometrically transformed co-ordinate system in which the co-ordinate axes are for example in a wavy line form or circular form or the co-ordinate axes extend completely irregularly. In that respect it is then further possible that the centroids of the first zones are constantly spaced in the direction of the first co-ordinate axis and in the direction of the second co-ordinate axis in the first region and the first and second zones are thus arranged in accordance with a regular grid raster defined by the co-ordinate system. In that respect, by varying the dimensions of the first regions, compliance with the foregoing conditions, in respect of the relative surface proportion, makes it easily possible to adjust first zones in the pattern region and the background region. In addition it is also possible for the spacings of the centroids of the first zones in the pattern region and in the background region to differ in at least one direction, which can also be used for observing the above-described conditions. In addition it is also possible that the first zones are not oriented to a grid raster but distributed randomly or pseudo-randomly in the first region, while observing the above-described conditions.

It has proven to be particularly advantageous if the minimum and the maximum mean surface coverage by the first zones with respect to a dimension of 300 μm×300 μm of each pattern region differs from the minimum and the maximum mean surface coverage by the first zones with respect to a dimension of 300 μm×300 μm of each background region by 5 to 30% in each case, differing for the minimum mean surface coverage preferably between 5 and 20% and for the maximum mean surface coverage between 15 and 30%. That ensures that a particularly high level of contrast between viewing in the incident light mode and the transillumination mode is achieved. It is particularly advantageous in that respect if the mean surface coverage by the first zones with respect to a dimension of 300 μm×300 μm in the pattern region and/or in the background region is respectively constant. In addition however it is also possible that the mean surface coverage by the first zones with respect to a dimension of 300 μm×300 μm in the pattern region and/or in the background region is varied to produce a second item of information. Thus it is possible for example—as already described hereinbefore—to provide a grey scale image, for example a portrait, which uniformly overlies the pattern region and the background region, as a second item of information which appears when viewed in the incident light mode and possibly when viewed in the transillumination mode and which when viewed in the transillumination mode is further superposed by the first item of information generated by the difference in contrast between the background region and the pattern region. Thus for example the pattern region has one or more first subregions and one or more second subregions each of dimensions of greater than 300 μm, wherein the surface area proportion of the first zones in the first subregions differs from the surface area proportions of the first zones in the second subregions between 2% and 50% respectively to produce a grey scale image in the transillumination mode.

In accordance with a preferred embodiment of the invention in the pattern region the total surface area of the first zones occupies a surface area proportion of less than 40% in relation to the total surface area of the pattern region, preferably between 5% and 30%. In that way it is possible to achieve particularly great differences in contrast between the information shown in the incident light and in the transillumination modes.

In accordance with a preferred embodiment of the invention the first surface structure used as a veiling structure within the first region is shaped into the reflection layer in at least 50%, advantageously in at least 90%, of the surface areas occupied by the first zones. In that respect it is particularly advantageous if the first surface structure within the background region and the pattern region is respectively shaped into the reflection layer in at least 50%, advantageously in at least 90%, of the surface area, occupied by the first zones, of the background region and the pattern region respectively. That achieves a veiling effect which makes it possible to further increase the difference in contrast between the background region and the pattern region when viewing in the transillumination mode. It has further proven to be particularly advantageous in that respect if the mean surface coverage of the pattern region and the background region by regions of first zones in which the first surface structure is shaped into the reflection layer is to be so selected that it diverges by not more than 30%, and is preferably constant. In that case the mean surface coverage is preferably related to a dimension of 300 μm×300 μm. By virtue of such a procedure the transitions between the background region and the pattern region are particularly well veiled so that the difference in contrast between the background region and the pattern region when viewing in the transillumination mode can be increased.

In accordance with a preferred embodiment of the invention the first surface structures are selected from the group of matt structure, macrostructure, and diffractive structure or represent a combination of those surface structures. The use of isotropic or anisotropic matt structures has proven to be particularly advantageous, which reflect the incident light in scattered form when viewed in the incident light mode and which by that effect particularly well prevent the first item of information from being recognisable in the incident light mode. Preferably in that respect matt structures are used, whose correlation lengths are in the region of 100 nm to 20 μm and whose structure depths are in the region of 50 nm to 5 μm.

In addition the use of binary or continuous lens structures has also proven desirable, which are shaped in the surfaces of the reflection layer and which effectively veil recognisability of the first item of information when viewed in the incident light mode due to the continuously changing deflection of the retroreflected light. In that respect it is possible for example to use structures in the form of cylinder lenses with a number of lines of 1 to 200 L/mm, but also spherical or aspherical lens shapes, as the surface structures. The structure depth of those structures is preferably in the region of 50 nm to 5 μm.

In addition the use of linear or crossed diffraction gratings, in particular sine gratings, as the first surface structure, has proven to be desirable. Preferably the spatial frequency of those diffraction gratings is in the region of 200 L/mm to 3000 L/mm and the structure depth of those structures is in the region of 50 nm to 500 nm. The use of other diffractive surface structures is also possible, wherein the use of surface structures which exhibit interesting, optically variable effects (for example a Kinegram®) can particularly well impede recognisability of the first information, in the incident light mode. Recognisability of the first information in the incident light mode is effectively veiled by diffraction of the light from the mirror reflection and due to the colour-splitting action of those structures.

Furthermore the use of asymmetric blaze gratings as the first surface structure has also proven desirable, in which respect here preferably the spatial frequency is selected to be in a region of 100 to 2000 L/mm and the structure depth in the region of 200 nm to 5 μm.

In accordance with a preferred embodiment of the invention not only is veiling of the first item of information caused by shaping of the first surface structure, but furthermore a fourth item of information is introduced into the first region, which becomes visible when viewed in the incident light and/or transillumination mode, as is also described in greater detail hereinafter. Preferably in this case the fourth item of information is already provided by the first surface structure in the incident light mode in a region at least partially covering over the region in which the first item of information is visible in the transillumination mode. In that way the human eye in the incident light mode is additionally ‘diverted’, which makes it additionally more difficult to recognise the first item of information when viewing in the incident light mode.

Preferably the first surface structure is thus provided in a second region which at least partially covers over the first region. In that respect it has proven to be particularly advantageous for the second region to project beyond the first region.

The second region can be shaped in pattern form to provide the fourth item of information. In addition it is also possible for the fourth item of information to be determined by one or more of the following parameters: shaping of the second region, shaping of the regions in which the first surface structure is shaped into the reflection layer, structure parameters of the first surface structure (structure parameters produce the respective optically variable effect, for example an image content of a hologram is coded in them), and shaping of regions in which different surface structures are shaped into the reflection layer, as the first surface structure.

In accordance with a preferred embodiment of the invention the second region has two or more subregions in which different surface structures are shaped into the reflection layer as the first surface structure. Preferably in that case those subregions are shaped in pattern form and are respectively of dimensions of greater than 300 μm, wherein at least a part of the fourth item of information is afforded by the patterned shaping of the subregions. It has been found that such a configuration of the first surface structure can particularly effectively prevent the first item of information from being recognisable when viewed in the incident light mode.

A particularly advantageous embodiment of the invention further provides that the second region has a multiplicity of first, uniformly shaped subregions and a multiplicity of second, uniformly shaped subregions, Wherein different surface structures are shaped into the reflection layer in the first subregions and in the second subregions and/or the first subregions and the second subregions involve a different configuration and the first and second subregions and optionally also further subregions are arranged in the form of a repetitive pattern. Preferably the repetitive pattern at least partially and preferably completely covers over the pattern region and the background region respectively. It has further proven desirable in that respect if the first and second subregions are aligned to a one- or two-dimensional grid raster. Such a configuration for the first surface structure particularly effectively prevents the first item of information from being recognisable when viewed in the incident light mode as perception of the human viewer is additionally influenced by the repetitive arrangement and thus recognisability of the first item of information when viewed in the incident light mode is additionally impeded.

In accordance with a preferred embodiment of the invention, in a second region arranged within the first region, a first surface structure is shaped into a replication layer of the security element or a first decoration layer is provided in the security element, which affords a fourth item of information. The fourth item of information is thus determined by the configuration of the second region and by the surface structure or the decoration layer respectively. Here preferably diffractive structures such as for example Kinegrams® and holograms, matt structures, in particular also anisotropic matt structures, or macrostructures, for example blaze gratings, or also asymmetric structures, are used as the surface structure. In particular decoration layers with a translucent body colour are used as the decoration layer, for example thin film layer systems, cholesteric liquid crystal layers or layers which include optically variable pigments. Depending on the respective nature of the surface structures and decoration layers used, the arrangement of those surface structures or decoration layers and the choice of the layers adjoining those surface structures or decoration layers, it is possible in that case to provide that the fourth item of information is visible only when viewed in the incident light mode, only when viewed in the transillumination mode, or both in the incident light and also the transillumination mode, as described hereinafter.

Thus it is possible for example for the first surface structure or the first decoration layer to be shaped or provided in the first zones covered over by the second region, but not in the first zones covered over by the second region, so that the fourth item of information appears only when viewed in the incident light mode. In addition it is also for the first surface structure or the first decoration layer to be shaped or provided in the second zones covered over by the second region, but not in the first zones covered over by the second region. The fourth item of information is thus visible in the transillumination mode and, depending on the respective configuration of the surrounding layers and the nature of the decoration layer used and the background, also in the incident light mode when viewed in that mode.

Preferably the replication layer in which the first surface structure is shaped or the first decoration layer is arranged between the metallic reflection layer and a first surface of the security element. Furthermore, in a third region arranged within the first region, a second surface structure is shaped in a replication layer of the security element or a second decoration layer is provided in the security element, which affords a fifth item of information, wherein the replication layer or the second decoration layer is arranged between the metallic reflection layer and a second surface of the security element. Thus when viewing from the side of the first surface in the incident light mode the fourth item of information is visible and when viewing from the side of the second surface in the incident light mode it is the fifth item of information that is visible. In addition it is also possible for the first surface structure or the first decoration layer to be shaped or provided in the second zones covered over by the second region. Then further preferably in a third region arranged within the first region, a second surface structure is shaped in a replication layer of the security element or a third decoration layer is provided in the security element, which affords a fifth item of information, wherein the replication layer or the second decoration layer is disposed between the metallic reflection layer and a surface of the security element so that, when viewing from the side of that surface in the incident light mode, the fifth item of information is visible while when viewing in the transillumination mode the fourth item of information is visible. In that respect it is further possible that, in a fourth region arranged within the first region, a third surface structure is shaped in a replication layer of the security element or a third decoration layer is provided in the security element, which affords a sixth item of information, the replication layer or the third decoration layer being arranged between the metallic reflection layer and the other surface of the security element so that when viewing from the side of the one surface in the incident light mode the fifth item of information is visible and when viewing from the side of the other surface in the incident light mode the sixth item of information is visible and when viewing in the transillumination mode the fourth item of information is visible.

Numerous interesting optical effects can be achieved by means of the invention by the variation in respect of the above-described variants. In that respect the second, third and/or fourth regions are preferably so selected that they at least partially overlap the pattern region and different optical recognisable items of information are presented in one and the same region when viewed in the transillumination mode and when viewed in the incident light mode, for the human viewer. In that sense it is also advantageous if the second region overlaps with the third region, the third with the fourth region and the second, the third and the fourth regions overlap. In addition it is also possible for the second, third and/or fourth region to correspond to the pattern region so that the pattern region shows a different, optically variable appearance when viewed in the incident light mode and the transillumination mode.

In addition it is possible, by virtue of the procedure described hereinafter, to provide an embodiment of a security element according to the invention, in which a different optical appearance shows in the incident light mode from the one side, in the incident light mode from the other side, and in the transillumination mode, for the human viewer:

Thus in accordance with a further preferred embodiment of the invention provided in the security element is a further partial metallic reflection layer which is spaced from the metallic reflection layer and which is provided in coincident relationship with the first metallic reflection layer in the first zones and is not provided in the second zones. Then a second surface structure is further shaped in the surface of the further metallic reflection layer, the second surface structure preferably differing from the first surface structure. In that case the second surface structure is preferably designed in the same fashion as described hereinbefore in relation to the first surface structure, or is provided in the second region. In that respect attention is directed to the foregoing description. Preferably in this case the second surface structure provides a fifth item of information which differs from the fourth item of information, that is to say the configuration of the second region, the (local) structure parameters of the first and second surface structures and/or the shaping of the regions in which the second surface structure is shaped into the further reflection layer differ. Thus, when viewing from the side of the reflection layer in the incident light mode the fourth item of information is visible, when viewing from the side of the further reflection layer the fifth item of information is visible and when viewing in the transillumination mode the first item of information is visible.

This embodiment of the invention can further also be varied with the above-described embodiments in which first and second surface structures respectively and/or first and second decoration layers respectively are provided on both sides of the metallic reflection layer in the security element to achieve the above-described effects.

In accordance with a preferred embodiment of the invention the security element is a security document, for example a value-bearing document such as a banknote, an identification document, for example a passport, or an authentication document, for example a label for product security protection. In that case the security element preferably has a carrier substrate, in particular including a paper substrate. In that case preferably an opening in window shape is introduced into the carrier substrate in the first region. The carrier film is preferably in the form of a strip and projects beyond the window-shaped opening on both sides at least in the direction of the longitudinal axis of the strip.

In addition it is also possible for the security element to be a lamination film. Besides the first region such a lamination film can also have one or more further regions in which there are further security elements. In this case the lamination film can also be shaped in the form of a band or a patch provided for application to a carrier substrate, for example to a paper carrier of a banknote.

The invention is described by way of example hereinafter by means of a number of embodiments with reference to the accompanying drawing.

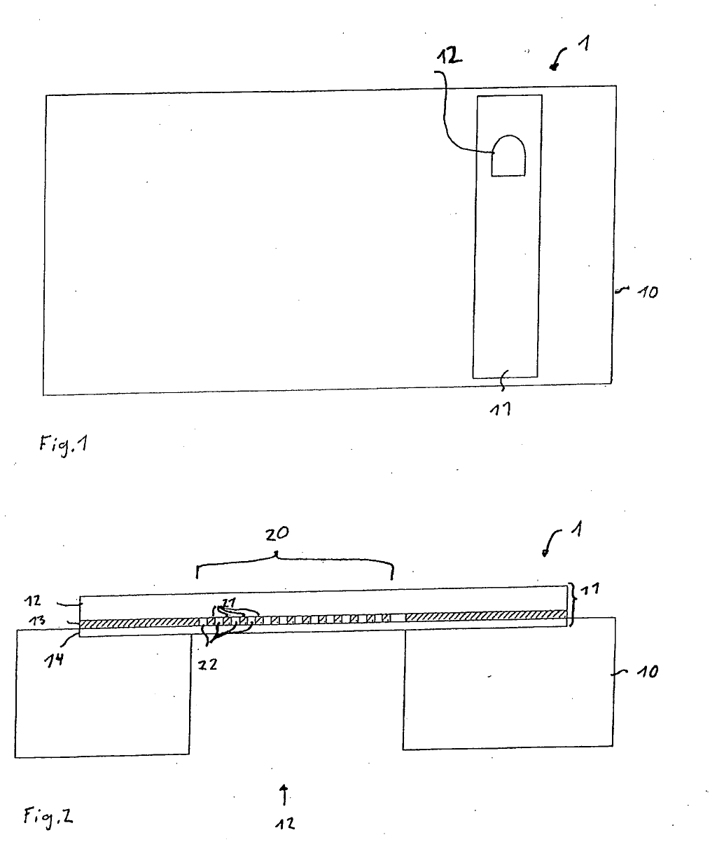

FIG. 1 shows a plan view of a security element according to the invention,

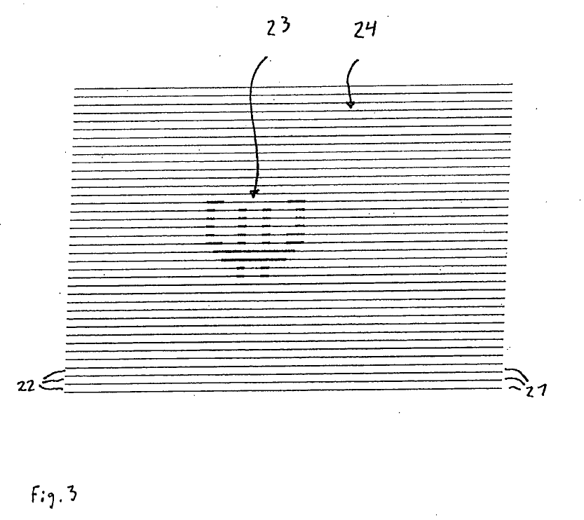

FIG. 2 shows a diagrammatic view in section of the security element of FIG. 1, which is not to scale,

FIG. 3 shows a diagrammatic view which is not to scale to illustrate the structuring of a metallic reflection layer of the security element of FIG. 1 in first and second zones,

FIG. 4 shows a diagrammatic view in section of a further security element according to the invention, which is not to scale,

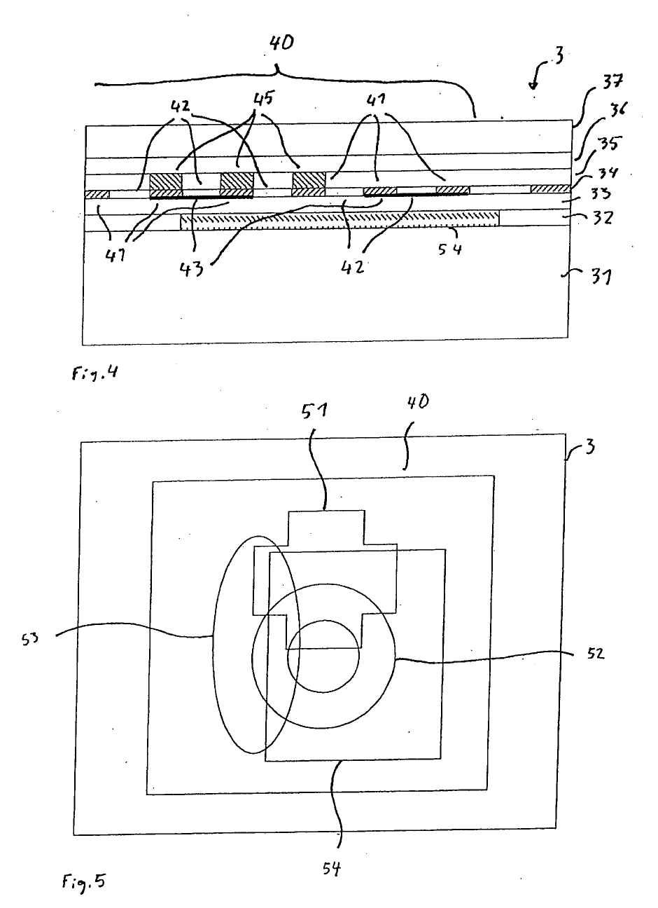

FIG. 5 shows a plan view of the security element of FIG. 4,

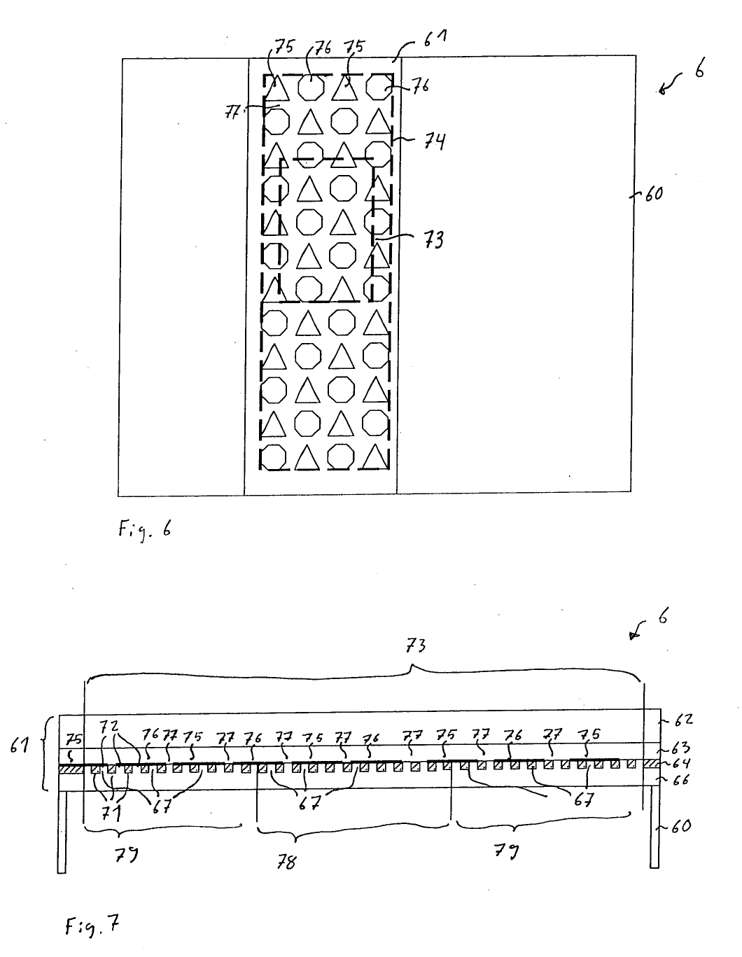

FIG. 6 shows a plan view of a further security element according to the invention,

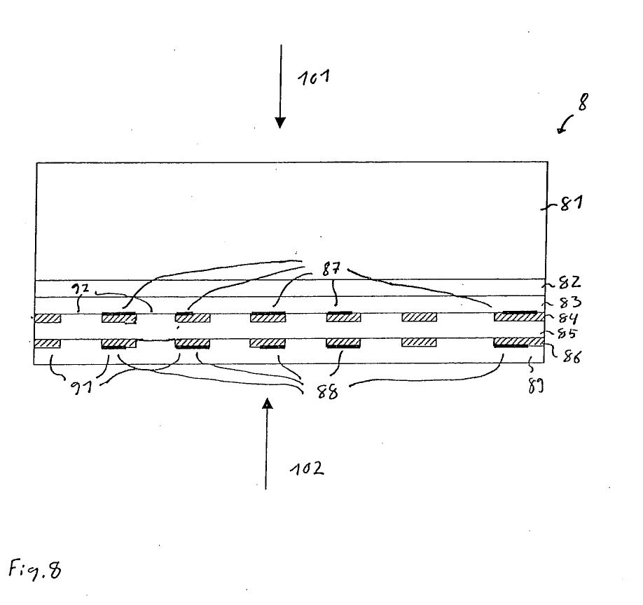

FIG. 7 shows a diagrammatic view in section of the security element of FIG. 6, which is not to scale, and

FIG. 8 shows a diagrammatic view in section of a further security element according to the invention, which is not to scale.

FIG. 1 shows a plan view of a security document 1 which is a banknote. It is however also possible for the security element 1 to represent a cheque, a traveller's cheque, a software certificate, an identity card or the like.

The security document 1 has a carrier substrate 10 and a film element 11 applied to the carrier substrate 10. The carrier substrate 10 comprises a paper material. The paper material is preferably a paper quality which is used for banknotes and which can be provided in known manner with watermarks, special imprints thereon and other security elements. Such further security elements comprise for example a steel intaglio printing, a microprinting or a reflecting security feature, for example a hologram, and a colour change element.

The carrier substrate comprising a paper material is preferably about 100 μm in thickness. In addition it is also possible for a multi-layer substrate comprising one or more paper and/or plastic material layer portions to be used as the carrier substrate, or for a carrier substrate entirely consisting of a plastic material substrate to be used as the carrier substrate.

As shown in FIG. 1 the carrier substrate has a window-like opening 12. That window-like opening can be arranged in any arrangement and configuration in the region of the film element 11. It is in that respect also possible for a plurality of window-like openings 12 to be arranged in the region of the film element 11. The window-like opening 12 is preferably introduced into the carrier substrate 10 before application of the film element 11 by means of a stamping or cutting operation. It is also possible for the carrier substrate not to have a window-like opening, but to be of a transparent configuration in the region of the window-shaped opening as shown in FIG. 1, particularly if the carrier substrate 10 is a plastic material substrate or a combination of a paper and plastic material substrate.

The film element 11 is preferably of a strip-shaped or thread-shaped form, preferably involving a strip width in the region of 4 to 30 mm. Preferably in that case the film element 11 extends transversely over the entire width or length of the carrier substrate 10, thereby simplifying application of the film element 11 from the point of view of production engineering.

The structure of the film element 11 will now be described in greater detail with reference to FIG. 2. FIG. 2 shows a sectional view of the security document 1 in the region of the window-shaped opening 12. As illustrated in FIG. 2 the film element 11 has a carrier film 12, a partial metallic reflection layer 13 and a protective lacquer layer and/or a bonding primer layer 14. It is also possible for the film element 11 to have still further layers, as is then also described with reference to FIG. 4.

The carrier film 12 is a PET or BOPP film of a layer thickness of 10 to 50 μm. The function of the carrier film 12 is to provide the necessary stability for bridging over the opening so that the choice to be preferably selected for the carrier film 12 is essentially determined by the width and length dimensioning of the opening 12. Preferably in this case the carrier film 12 is formed by a plastic material film of a layer thickness of at least 10 μm, preferably between 10 and 24 μm.

The metallic reflection layer 13 comprises for example aluminium, chromium, copper, gold or silver or an alloy of those materials and is preferably applied by means of vapour deposition or sputtering. The thickness of the metallic reflection layer 13 is preferably 20 nm to 100 nm so that it appears opaque to a human viewer. In a region 20 arranged within the region of the window-like openings, the film element 11 is transparent or semi-transparent. The metallic reflection layer 13 is of a partial configuration in the region 20 and is provided only in the region of a multiplicity of first zones 21. The region 20 is thus subdivided into a multiplicity of first zones 21 and second zones 22, the metallic reflection layer being provided in the first zones 21 and the metallic reflection layer not being provided in the second zones 22. In the zones 22 the metal is thus for example subsequently removed by demetallisation, for example by positive/negative etching, by means of a washing mask or by means of laser ablation. It is also possible for the metal to be applied only in the first zones 21 but not in the second zones 22, by means of a vapour deposition mask.

In addition it is also possible that, besides the region 20, provided in the region of the window-like opening 12 there are still further regions which do not overlap with the region 20 and in which there are further security elements, in particular transmissive security elements. In those other regions, the reflection layer 13 may not be provided, it may be provided over the full surface area or it may be structured differently from in the region 20. In that respect it is also possible for the region 20 to be shaped in the form of a configuration affording a given item of information, for example in the form of a digit, a letter or a symbol.

The structuring of the metallic reflection layer 13 in the region 20 will now be described in detail with reference to FIG. 3. FIG. 3 shows a plan view which is not to scale of a portion of the metallic reflection layer in the region 20. As shown in FIG. 3 the first zones 21 in which the metal layer is provided and the second zones 22 alternate so that a first zone 21 is followed by a second zone 22 and a second zone 22 is followed by a first zone 21. The centroids of successive first zones 21 are arranged spaced from each other less than 300 μm, in the embodiment shown in FIG. 3 being spaced from each other at about 100 μm. As shown in FIG. 3 in this case the first zones are of a band-shaped configuration and arranged substantially parallel to each other. The longitudinal axis of the first zones 21 and the second zones 22 are oriented in the direction of a first co-ordinate axis of a co-ordinate system determined by the first co-ordinate axis defined in that way and a second co-ordinate axis at a right angle thereto. In addition, as indicated in FIG. 3, the centroids of the first zones 21 are substantially constantly spaced along the first co-ordinate axis, in the direction of the second co-ordinate axis.

In addition, there is a pattern region 23 which is completely or partially enclosed by a background region 24 and in which, as indicated in FIG. 3 but not to scale, the spacing of successive second regions is selected to be different in relation to the spacing of successive regions in the background region 24, by 5 to 30%. Thus the width of the first zone 21 in the background region 24 in the FIG. 3 embodiment is 60 μm and in the background region 23 it is 80 μm with a grid raster of 100 μm. The pattern region is in the shape of a symbol ‘ [symbol] ’. When the security document 1 is viewed in the transillumination mode, an item of information defined by the configuration of the pattern region 23 is shown in the region 22, and thus, against a light background, there is a symbol shown in a markedly darker shade, here the symbol ‘ [symbol] ’. When the security document 1 is viewed in the incident light mode that impression disappears again.

As already stated hereinbefore it is also possible for the centroids of the first zones to be oriented to a geometrically transformed co-ordinate system so that the centroids of the first zones 21 are oriented for example in the form of wavy lines or in the form of concentric circles. The spacing of the first zones 21 from each other is here preferably also kept substantially constant so that the symbol ‘ [symbol] ’ appears against a uniformly light background when viewed in the transillumination mode. It is however also possible for the spacing of the first zones 21 from each other to be varied over the entire width of the first zones or in region-wise manner, and thus the first item of information is superposed both in the incident light mode and also in the transillumination mode by a second item of information, for example a corresponding grey scale image. In addition it is also possible for the first zones 21 and the second zones 22 to alternate both in a first direction and also in a second direction different therefrom. Preferably in that case the first zones alternate both in the direction of the first co-ordinate axis and also in the direction of the second co-ordinate axis.

A further embodiment of the invention will now be described with reference to FIG. 4. FIG. 4 shows a security element 3 which is a lamination film. That lamination film can be used for example as a film element like the film element 11 for application to a carrier substrate of a security document, or it can also represent a region of a film web which has not yet been individually separated off.

The security element 3 has a carrier film 31, a decoration layer 32, a replication layer 33, a metallic reflection layer 34, a decoration layer 35, a protective lacquer layer 36 and an adhesive layer 37. The carrier film 31 comprises a PET film of a thickness of 12 μm. The decoration layer 32 is provided only region-wise in a region 54 of the security element 3. In this region the decoration layer 32 comprises a thin film layer system which when viewed by the human viewer shows colour shift effects depending on the viewing angle. That thin film layer system preferably comprises a plurality of alternating high-refraction and low-refraction layers, the layer thicknesses of which are respectively so selected that they satisfy the λ/2 or λ/4 condition for one or more wavelengths in the visible spectrum of light (λ=wavelength of light; optical density, that is to say geometrical density multiplied by the refractive index in the respective medium satisfies the λ/2 and the λ/4 condition respectively). In addition it is possible to use only one optical spacer layer which satisfies that condition and which is preferably adjoined in the direction of the carrier film 31 by an absorption layer, for example involving 10% absorption, preferably in the form of a thin metallic layer.

The replication layer 33 is 0.5 to 5 μm in thickness and comprises a thermal replication layer or a UV replication layer. As indicated in FIG. 3 a surface structure is shaped in a region 52 in the replication layer 33 by thermal replication by means of heat/pressure or by UV replication. The surface structure 43 is preferably an isotropic or anisotropic matt structure. It is however also possible for the surface structure to be another diffractive structure, for example a Kinegram®, a hologram, a kinoform or a zero-order diffraction structure. It is also possible for the surface structure to be a linear or crossed sine grating or a blaze grating, but also a lens-like structure, a macrostructure or a combination of the aforementioned structures.

The metallic reflection layer 34 is applied to the replication layer 33. As indicated in FIG. 4 in this case the metallic reflection layer 34 is only partially provided in first zones 41 in a region 40, and is not provided in second zones 42. The metallic reflection layer 34 is 20 nm to 100 nm in thickness and thus appears opaque to the human viewer when viewed in the incident light mode. The arrangement and configuration of the first zones 41 and second zones 42 are in this case selected to be like the arrangement of the first zones 21 and the second zones 22 in the FIG. 3 embodiment. Instead of a pattern region 23 shaped in the form of a symbol ‘ [symbol] ’, here the pattern region 51 is shaped in the form of a cross, in which, as explained hereinbefore, the spacing of successive second zones 42 is selected to differ by 5 to 30% with respect to the spacing of successive second zones 42 in the background region, that is to say transmission in the pattern region can be either increased or reduced, relative to the background region. In this respect the view in FIG. 4 is not true to scale in particular in regard to the number of first zones 41 and second zones 42 in the regions 40, 51, 53, 52 and 54, that is to say in those regions there are orders of magnitude more of the zones 41 and 42, than is indicated in FIG. 4.

The decoration layer 35 is partially applied to the metallic reflection layer 34. In this case the decoration layer 35 is provided only in the first zones 41 which are covered over by the region 53, that is to say only in the regions 45 indicated, in FIG. 4. For that purpose the decoration layer 35 is only applied in the regions 45 to the metallic reflection layer 34. It is also possible for the decoration layer 35 to be applied to the metallic reflection layer 34 over the full surface area in the region 53, for example by printing, and then partially removed again in the zones 42, preferably together with the region of the metallic reflection layer 34 in the zones 42.

The decoration layer 35 is a coloured lacquer layer, preferably of a thickness of between 2 and 3 μm. It is however also possible for the decoration layer 35 also to be a thin film layer system or a cross-linked cholesteric liquid crystal layer or a layer having variable pigments. The decoration layer 35 can thus include for example liquid crystal pigments or thin film layer pigments, but also luminescent or thermochromic pigments.

The protective lacquer layer 36 is about 1 to 5 μm in thickness. It would also be possible to dispense with that layer. The adhesive layer 37 preferably comprises a thermally activatable adhesive and is 1 to 5 μm in thickness. It is also possible for the adhesive layer 37 to comprise a UV-activatable adhesive or a cold adhesive. It is also possible to dispense with the adhesive layer 37. It is also possible for the security element 3 to have still further decoration layers which can be like the decoration layers 32 and 35, or also include other further layers. In that respect the layers of the security element 31 are to be of such a nature that a transparent or semi-transparent impression is afforded for the human viewer in the region 40 of the security element 3. This means that all layers of the security element 3 are transparent or semi-transparent for the human viewer in the region 40.

When the security element 3 is viewed by a human viewer the following items of information present themselves thereto in dependence on the viewing situation:

When viewing the security element 3 from the side of the carrier film 31 in the incident light mode the colour change effect generated by the thin film layer system of the decoration layer 32 shows itself in the region 54. The viewer is thus presented with a first item of information determined by the configuration of the region 54 and the colour change effect defined by the thin film layer system.

In the region 52, there is the optical effect determined by the surface structure 43, for example a metallically matt appearance which stands out clearly against the surrounding background. The viewer is thus presented with a second item of information determined by the configuration of the region 52 and by the surface structure 43.

If the security element 3 is viewed from the side of the adhesive layer 37 by the human viewer the optical effect generated by the decoration layer 37 is shown in the region 53. If a coloured lacquer layer is used as the decoration layer 35 then the region 53 differs from the surrounding region by virtue of the coloration in that colour. If the decoration layer 35 used is a thin film layer or a lacquer layer containing optically variable pigments, then a corresponding colour change effect is shown in the region 53. A third item of information is thus presented to the human viewer, which is determined by the configuration of the region 53 and by the material of the decoration layer 35. In addition, when viewing from the side of the adhesive layer 37, the optical impression generated by the thin film layer system of the decoration layer 32, therefore also the first item of information, is also shown in the region 54.

When viewed in the transillumination mode the region 51 appears darker/lighter than the surrounding region. Thus in the transillumination mode the human viewer is given a fourth item of information determined by the configuration of the pattern region 51. In addition it is also possible for the optical effect generated by the surface structure 43 to be additionally also shown in attenuated form in the region 52 for the human viewer when viewing in the transillumination mode. That can be avoided by the surface structure 43 being shaped only in the region of the first zones 41 covered over by the region 52.

As indicated hereinbefore therefore the security element 3 affords the human viewer completely different items of information, depending on the respective viewing situation, whereby the security element 3 provides a clearly recognisable security feature which can only be imitated with difficulty.

A further embodiment of the invention is described hereinafter with reference to FIGS. 6 and 7. FIG. 6 shows a plan view of a portion of a security document 6 which is for example a value-bearing document such as a banknote. FIG. 7 shows a diagrammatic sectional view which is not true to scale of a portion of the security document 6.

The security document 6 has a carrier substrate 60 and a film element 61 applied to the carrier substrate 60. In regard to the configuration of the security document 60 and the choice of the materials used for the carrier substrate 60, attention is directed to the description in that respect, referring to FIG. 1. The film element 61 is preferably of a strip-shaped form, preferably involving a strip width in the region of 4 to 30 mm. The film element 61 has a first region 73 and a second region 74 which itself in turn includes a plurality of subregions 75 and 76 shaped in pattern form, and a background region 77 surrounding those subregions. The carrier substrate 60, like the carrier substrate 10 in FIG. 1, has a window-shaped opening or a correspondingly transparent region in which it is possible to view the film element 61 both from the top side and also—through the opening—from the rear side. The film element 61 is now positioned on the carrier substrate 60 in such a way that the first region 73 of the film element 61 is arranged in the region of that window-shaped opening or the transparent region of the carrier substrate 60 so that the first region of the film element 73 can be viewed both from the front side and also from the rear side of the security document 60. The film element 61 is further of such a configuration in the region 73 that it appears transparent or semi-transparent to the human viewer in the transillumination mode and a different optical appearance is presented in the incident light mode and in the transillumination mode. The film element 61 is now provided in the region of the window-shaped opening, as shown in FIG. 7. The film element 61 has a transparent carrier film 62, a replication layer 63, a metallic reflection layer 64 and a protective lacquer layer 66. In this case, in the second region 73, all layers of the film element 61, except for the metallic reflection layer 64, comprise a transparent material in order thereby to permit a transparent or semi-transparent optical impression in the transillumination mode.

In regard to the configuration of those layers attention is directed to the description relating to the corresponding layers as shown in FIGS. 1, 2 and 4.

The metallic reflection layer 64 is partially provided in the region 73 and is provided only in the region of a multiplicity of first zones 71. The region 73 is thus subdivided into a multiplicity of first zones 71 and second zones 72, wherein the metallic reflection layer is provided in the first zones 71 and the metallic reflection layer is not provided in the second zones 72. First zones 71 and second zones 72 are provided alternately, as shown in FIG. 7. In addition, the region 73 is subdivided into a pattern region 78 and a background region 79 which at least partially surrounds the pattern region 78. Each of the first and second zones, within the region 73, is of a smallest dimension of less than 300 μm, the arrangement and shaping of the first and second zones being so selected that the surface area proportion of the first zones 71, in relation to the total surface area of the pattern region 78, differs from the surface area proportion of the first zones 71, in relation to the total surface area of the background region 79, by 5 to 30%. In addition, a surface structure 67 is formed in the replication layer 63 within the first region 73 at least in a part of the surface of the background region 79 and the pattern region 78, that is occupied by the first zones, and is thereby also correspondingly shaped in the metallic reflection layer 64 applied to the replication layer 63. The surface structure 67 at least partially deflects the incident light out of the mirror reflection of the plane defined by the film element 61.

In that respect structuring of the metallic reflection layer 64 can be effected in particular like the structuring of the metallic reflection layers 13 and 34 shown in FIGS. 2, 3 and 4. In addition, by virtue of the surface structure 67 further provided in this embodiment, it is also possible to additionally implement structuring variants for the metallic reflection layer 64 in production of the film element 61. Thus it is possible that the first zones 71 are not shaped in line form and are also not aligned with a line grid raster. Preferably however in this case also the centroids of successive first zones 71 are spaced from each other less than 300 μm, preferably spaced at less than 100 μm. In addition not only the smallest but also the largest dimensioning of the first zones 71 is preferably less than 300 μm, further preferably less than 200 μm. Alignment of the first zones 71 on the basis of a two-dimensional, also transformed grid raster is possible and likewise a random or pseudo-random arrangement of the first zones 71, by which also interference effects can further be avoided. In the embodiment illustrated here the mean surface coverage by the first zones, with respect to a dimension of 300 μm*300 μm in the pattern region 78 is preferably in a region of 40 to 70% and in the background region it is 60 to 90%, wherein moreover the minimum mean surface coverage by the first zones in the pattern region 78 and the background region 79 differs by 5 to 30%, preferably by 5 to 20%, and the maximum mean surface coverage in the pattern region 78 and the background region 79 differs by 5% to 30%, preferably by 15% to 30%.

The surface structure 67 is a diffractive surface structure which region-wise has a different spatial frequency and orientation in respect of the grating lines. Preferably the surface structure 67 is a Kinegram®. As shown in FIG. 7 the surface structure 76 is not provided in the entire surface of the first region 73, that is occupied by the first zones 71. Complete occupation of the first zones 71 by the surface structures 76 is possible. Preferably the surface structure 67 is shaped into the reflection layer 64 within the first region 72 in at least 50% of the surface area occupied by the first zones 71 and in that case is shaped within the background region in at least 30% of the surfaces occupied by the first zones and in the pattern region in at least 30% of the surfaces occupied by the first zones. Preferably the surface area proportion of the region of the reflection layer 64 in which the surface structure 67 is shaped into first zones 71 is identical in the background region and in the pattern region or differs by not more than 20%. In addition, surface coverage which is as uniform as possible of the pattern region and the background region is an aim that is sought to be achieved by virtue of regions of first zones in which the surface structure 67 is shaped into the reflection layer, more specifically independently of the coverage of the pattern region 78 and the background region 79 respectively with first zones 71. The mean surface coverage, preferably with respect to a dimension of 300 μm*300 μm by those regions should diverge by not more than 30%.

As indicated in FIGS. 6 and 7 the second region 74 has a multiplicity of first subregions 75 and second subregions 76 which are each shaped differently. In this case the subregions 75 and 76 are each preferably of a dimension of 0.1 to 10 mm. In the subregions 75 and 76 different surface structures are shaped into the reflection layer 64, as the surface structure 67, so that the subregions 75 and 76 respectively provide a different, preferably optically variable impression. Thus in the embodiment of FIG. 6 different diffractive structures are shaped in the subregions 75 and 76. It is however also possible for the structures shaped in the subregions 75 and 76 to be selected from matt structures, diffractive structures, asymmetric structures and lens-shaped structures or formed by a combination of such structures. Thus it is possible for example for surface structures to be shaped in the subregions 75 and 76, which surface structures are to be associated with different types of structures, for example a matt structure in the regions 75 and a Kinegram® exhibiting an optically variable effect in the subregion 76. In the embodiment of FIGS. 6 and 7 the background region 77 surrounding the subregions 75 and 76 is not occupied by the surface structure 77. It is however also possible for one of the above-mentioned surface structures to be shaped in the background region 77 into the reflection layer 64, which differs from the surface structures shaped in the subregions 75 and 76. In addition it is also possible, besides the subregions 75 and 76, also to provide further subregions in the region 74, in which a further surface structure which differs from the surface structure in the subregions 75 and 76 is shaped.

Furthermore it is also possible for the same surface structure to be shaped into the reflection layer 64 in the subregions 75 and 76, but no surface structure or a surface structure differing from that surface structure is shaped into the reflection layer 64 in the background region 77. The peripheral edge of the subregions 75 and 76 thus stands out against the background region 77 and can be perceived by the human viewer as a different item of optically variable information.

As indicated in FIG. 6 the subregions 75 and 76 are arranged in a regular repetitive pattern which completely covers over the region 73. That repetitive arrangement and the influence produced thereby on the human viewer provides for particularly good veiling of the first item of information when viewed in the incident light mode.

When viewing the security document 6 in the incident light mode from the front side the relatively simple repetitive pattern which is indicated in FIG. 6 and which further presents an optically variable appearance is thus shown in the entire region 74. In the transillumination mode, the item of information which is provided in the form of the configuration of the pattern region 78 is surprisingly shown in the region 73 for the human viewer, for example a complex image of a human head against a light background, or vice-versa.

It is also possible for the embodiment described hereinbefore with reference to FIGS. 6 and 7 also to be combined with the embodiment shown in FIGS. 4 and 5, and thus, besides the layers shown in FIG. 7, it may also have for example the further layer of FIG. 4 in order in that way to show still further different, preferably overlapping items of information, when viewing the document in the incident light mode and in the transillumination mode from different respective sides.

It is also possible for the embodiment of FIGS. 6 and 7, the embodiment of FIGS. 1 to 3 or the embodiment of FIGS. 4 and 5 to be additionally designed as described hereinafter with reference to FIG. 8.

FIG. 8 shows a security element 8 in the form of a film body having a transparent carrier film 81, a bonding primer layer, a release layer or transparent decoration layer 82, a first replication layer 83, a first metallic reflection layer 84, a second replication layer 85, a second metallic reflection layer 86 and a protective lacquer layer 89. In regard to the configuration of those layers attention is directed to the description in that respect with reference to FIGS. 1 to 7. The reflection layers 84 and 86, as explained hereinbefore, are subdivided into first zones 91 in which the reflection layers are provided and second zones 92 in which the reflection layers are not provided. The reflection layers 84 and 86 are respectively provided in coincident relationship in the first zones 91 and are not provided in the second zones 92. In regard to shaping the first zones 91 in the background region and in the pattern region, attention is directed to the foregoing description relating to FIGS. 1 to 7. Furthermore, in the first reflection layer 84 a first surface structure 87 and in the second reflection layer 86 a second surface structure 88 are at least region-wise shaped into the first zones 91, as shown by way of example in FIG. 8. In regard to the choice of the surface structures 87 and 88 and the shape of the regions occupied by those surface structures, attention is directed to the foregoing description, in particular with reference to FIG. 7.

When the security element 8 is viewed from a first side 101 in the incident light mode the optical information generated by the surface structures 87 is shown. When the security element is viewed from the opposite side 102 in the incident light mode, the optical information generated by the surface structures 88 is shown, for example the representation indicated in FIG. 6. When the security element 8 is viewed in the transillumination mode, the optical information determined by the configuration of the pattern region is shown, for example a representation of a human head, both when viewing from the side 101 and also when viewing from the side 102.

1-54. (canceled)

55. A security element in the form of a multi-layer film body for viewing in an incident light mode and in a transillumination mode, wherein the security element, in a first region which is transparent or semi-transparent for the human viewer in the transillumination mode, has a carrier film and a partial metallic reflection layer wherein,
in the first region first zones in which the metallic reflection layer is provided and second zones in which the metallic reflection layer is not provided are arranged alternately with a spacing of the centroids of successive first zones of less than 300 μm, the first region has at least one pattern region with dimensions >300 μm and a background region adjoining the pattern region and at least partially surrounding the pattern region, and wherein the spacing of successive second zones in the pattern region differs by 5 to 30% with respect to the spacing of successive second zones in the background region, whereby an item of information determined by the shaping of the pattern region becomes visible to the human viewer in the transillumination mode.

56. A security element according to claim 55, wherein the width of the first zones is less than 200 μm and the length of the first zones is >1000 μm.

57. A security element according to claim 55, wherein the width of the first zones is between 10 μm and 100 μm.

58. A security element according to claim 55, wherein the first zones are of a line-shaped or strip-shaped configuration.

59. A security element according to claim 55, wherein, in the first region, the total surface area of the first zones occupies an area proportion of less than 50% of the total area of the first and second zones.

60. A security element according to claim 55, wherein the first zones are arranged substantially parallel to each other, wherein the longitudinal axes of the first zones are oriented in the direction of a first co-ordinate axis of a co-ordinate system defined by the first co-ordinate axis and a second co-ordinate axis different therefrom in the first region.

61. A security element according to claim 60, wherein first zones extend over the boundary between a pattern region and a background region and thus the respective first zone is provided both in the pattern region and also in the background region.

62. A security element according to claim 61, wherein first zones extend over the entire surface extent of the first region in the direction of the first co-ordinate axis.

63. A security element according to claim 60, wherein the centroid lines of the first zones are substantially constantly spaced along the first co-ordinate axis in the direction of the second co-ordinate axis.

64. A security element according to claim 60, wherein the centroid lines of the first zones are varied along the first co-ordinate axis in the direction of the second co-ordinate axis in accordance with an item of information specifying a second item of information.

65. A security element according to claim 63, wherein the centroid lines of the first zones are spaced from each other at between 30 and 40 μm in the direction of the second co-ordinate axis.

66. A security element according to claim 55, wherein the width of the first zones in the pattern region and the width of the first zones in the background region differ by 10 to 30%.

67. A security element according to claim 55, wherein, in the first zones, an isotropic or an anisotropic matt structure is shaped into the surface of the reflection layer.

68. A security element in the form of a multi-layer film body for viewing in an incident light mode and in a transillumination mode, wherein the security element, in a first region which is transparent or semi-transparent for the human viewer in the transillumination mode, has a carrier film and a partial metallic reflection layer, wherein
first zones in which the metallic reflection layer is provided and second zones in which the metallic reflection layer is not provided are provided alternately in the first region, and wherein each of the first and second zones within the first region is of a smallest dimension of less than 300 μm, and the first region has at least one pattern region of dimensions of greater than 300 μm and at least one background region adjoining the pattern region and at least partially enclosing the pattern region, wherein, within the first region in at least a part of the area, occupied by the first zones of the background region and of the pattern region, a first surface structure is shaped into the reflection layer, which deflects the incident light at least partially out of the mirror reflection of the plane defined by the film body and the surface area proportion of the first zones in relation to the total surface area of each pattern region differs from the surface area proportion of the first zones in relation to the total surface area of each background region by 5 to 30%, whereby a first item of information determined by the shaping of the pattern region becomes visible to the human viewer in the transillumination mode.

69. A security element according to claim 68, wherein the centroids of successive first zones are spaced at less than 300 μm from each other at least in one direction.

70. A security element according to claim 69, wherein the centroids of successive first zones are spaced from each other at less than 300 μm in the direction of a first co-ordinate axis and in the direction of a second co-ordinate axis differing therefrom of a co-ordinate system defined in the first region by said co-ordinate axes.

71. A security element according to claim 70, wherein the centroids of the first zones are constantly spaced in the direction of the first co-ordinate axis and in the direction of the second co-ordinate axis in the first region.

72. A security element according to claim 68, wherein the spacings of the centroids of the first zones in the pattern region and in the background region differ in at least one direction.

73. A security element according to claim 68, wherein the minimum and the maximum mean surface coverage by the first zones with respect to a dimension of 300 μm×300 μm of each pattern region differs from the minimum and the maximum mean surface coverage by the first zones with respect to a dimension of 300 μm×300 μm of each background region by 5 to 30% in each case.

74. A security element according to claim 68, wherein the mean surface coverage by the first zones with respect to a dimension of 300 μm×300 μm in the pattern region and/or in the background region is respectively constant.

75. A security element according to claim 68, wherein the mean surface coverage by the first zones with respect to a dimension of 300 μm×300 μm in the pattern region and/or in the background region is varied to produce a second item of information.

76. A security element according to claim 68, wherein, in the pattern region, the total surface area of the first zones occupies a surface area proportion of less than 40% in relation to the total surface area of the pattern region.

77. A security element according to claim 68, wherein the first surface structure within the first region is shaped into the reflection layer in at least 50% of the surface area occupied by the first zones.

78. A security element according to claim 68, wherein the first surface structure within the background region and the pattern region is respectively shaped into the reflection layer in at least 30% of the surface area, occupied by the first zones, of the background region and the pattern region respectively.

79. A security element according to claim 68, wherein the surface area proportions of the regions of the reflection layer, in which the first surface structure is shaped into the first zones, differs in the background region and in the pattern region by not more than 20%.

80. A security element according to claim 68, wherein the mean surface coverage of the pattern region and the background region by regions of first zones in which the first surface structure is shaped into the reflection layer, with respect to a dimension of 300 μm×300 μm, differs by not more than 30%.

81. A security element according to claim 68, wherein the first surface structure is selected from the group of isotropic or anisotropic matt structures, lens structures, linear or crossed diffraction gratings, or represents a combination of surface structures of those groups.

82. A security element according to claim 68, wherein the first surface structure in the incident light mode provides a fourth item of information in a region which at least partially covers over the region in which the first item of information is visible in the transillumination mode.

83. A security element according to claim 68, wherein the first surface structure is provided in a second region which at least partially covers over the first region.

84. A security element according to claim 83, wherein the second region projects beyond the first region.

85. A security element according to claim 68, wherein the second region can be shaped in pattern form to provide a fourth item of information.

86. A security element according to claim 83, wherein the second region has two or more subregions in which different surface structures are shaped into the reflection layer as the first surface structure.

87. A security element according to claim 86, wherein the subregions are shaped in pattern form and are respectively of dimensions of greater than 300 μm, wherein at least a part of the fourth item of information is afforded by the patterned shaping of the subregions.

88. A security element according to claim 68, wherein the second region has a multiplicity of first, uniformly shaped subregions and a multiplicity of second, uniformly shaped subregions, wherein different surface structures are shaped into the reflection layer in the first subregions and in the second subregions and/or the first subregions and the second subregions involve a different configuration and the first and second subregions and further subregions are arranged in the form of a repetitive pattern.

89. A security element according to claim 88, wherein the repetitive pattern at least partially covers over the pattern region and the background region respectively.

90. A security element according to claim 88, wherein the first and second subregions are aligned to a one- or two-dimensional grid raster.

91. A security element according to claim 68, wherein the security element has a further partial metallic reflection layer spaced from the metallic reflection layer and the further metallic reflection layer is provided in coincident relationship with the first metallic reflection layer in the first zones and is not provided in the second zones, and a second surface structure (88) is shaped into the surface of the further metallic reflection layer.

92. A security element according to claim 91, wherein the first surface structure provides a fourth item of information and the second surface structure provides a fifth item of information different from the fourth item of information so that when viewing from the side of the reflection layer in the incident light mode, the fourth item of information becomes visible, when viewing from the side of the further reflection layer, the fifth item of information becomes visible and when viewing in the transillumination mode, the first item of information becomes visible.

93. A security element according to claim 91, wherein the second surface structure is designed like the first surface structure or is provided in the first and second region respectively.

94. A security element according to claim 68, wherein, in a second region arranged within the first region, a first surface structure is shaped in a replication layer of the security element or a first decoration layer is provided in the security element, which provides a fourth item of information.

95. A security element according to claim 94, wherein the replication layer or the first decoration layer is arranged between the metallic reflection layer and a first surface of the security element, in a third region arranged within the first region, a second surface structure is shaped in a replication layer of the security element or a second decoration layer is provided in the security element, affording a fifth item of information, and wherein the replication layer or the second decoration layer is arranged between the metallic reflection layer and a second surface of the security element so that, when viewing from the side of the first surface in the incident light mode, the fourth item of information is visible and, when viewing from the side of the second surface in the incident light mode, the fifth item of information is visible.

96. A security element according to claim 94, wherein the first and/or second surface structure or the first and/or second decoration layer is shaped or provided in the first zones which are covered by the second region and the third region respectively, but not in the first zones which are covered by the second region or the third region respectively.

97. A security element according to claim 94, wherein the first surface structure or the first decoration layer is shaped or provided in the second zones which are covered by the second region but not in the first zones which are covered by the second region, so that the fourth item of information is visible in the transillumination mode.

98. A security element according to claim 94, wherein the first surface structure or the first decoration layer is shaped or provided in the second zones which are covered by the second region, in a third region arranged within the first region, a second surface structure is shaped in a replication layer of the security element or a second decoration layer is provided in the security element, providing a fifth item of information, wherein the replication layer or the second decoration layer is arranged between the metallic reflection layer and a second surface of the security element so that, when viewing from the side of the second surface in the incident light mode, the fifth item of information is visible and, when viewing in the transillumination mode, the fourth item of information is visible.

99. A security element according to claim 98, wherein, in a fourth region arranged within the first region, a third surface structure is shaped in a replication layer of the security element or a third decoration layer is provided in the security element, providing a sixth item of information, wherein the replication layer or the third decoration layer is arranged between the metallic reflection layer and a first surface of the security element so that, when viewing from the side of the first surface in the incident light mode, the fifth item of information is visible and, when viewing from the side of the second surface in the incident light mode, the sixth item of information is visible.

100. A security element according to claim 94, wherein the second, third and/or fourth regions overlap with the pattern region.

101. A security element according to claim 94, wherein the second region overlaps with the third region, the third overlaps with the fourth region or the second, third and fourth regions overlap.

102. A security element according to claim 94, wherein the first, second or third surface structure is a surface structure selected from the group of matt structure, diffractive structure or macrostructure.

103. A security element according to claim 94, wherein the first, second or third decoration layer is a thin film layer system, a liquid crystal layer and/or a layer containing optically variable pigments.

104. A security element according to claim 68, wherein one or more of the first zones are microstructured to provide a third item of information.

105. A security element according to claim 68, wherein the security element is a security document.

106. A security element according to claim 105, wherein the security element has a carrier substrate, including a paper substrate, and wherein, in the first region, a window-shaped opening is introduced into the carrier substrate.

107. A security element according to claim 105, wherein the carrier film is in the form of a strip and the window-shaped opening projects on both sides at least in the direction of the longitudinal axis of the strip.

108. A security element according to claim 68, wherein the security element is a lamination film.
